(19) United States
(12) Patent Application Publication
(10) Pub. No.: US 2012/0221492 A1
(43) Pub. Date: Aug. 30, 2012

(54) MODEL HOME AND METHODS OF USE THEREOF

(75) Inventors: Chip R. Herro, Goodyear, AZ (US); Michael P. Mancini, Scottsdale, AZ (US)

(73) Assignee: MERITAGE HOMES CORPORATION, Scottsdale, AZ (US)

(21) Appl. No.: 13/037,255

(22) Filed: Feb. 28, 2011

(51) Int. Cl. G06Q 90/00; E04H 14/00

(52) U.S. Cl. 705/500; 52/173.1

(57) ABSTRACT

A model home can include common features with one or more homes being offered for sale. Typically, the common features are energy-efficient features. The model home can include one or more partially exposed features configured to reveal to prospective buyers the common features of the model home and the homes being offered for sale. The partially exposed features can include, for example, exposing the interior construction of portions of the model home, such as the interior construction of one or more walls. The partially exposed features of the model home can assist the prospective buyers understand the benefits that the common features provide, thereby encouraging the prospective buyers' interest in the homes being offered for sale.

### BACKGROUND

1. Field

Certain embodiments disclosed herein relate to homes having features in common with other homes, and are particularly related to model homes, and method of use thereof, having partially exposed features related to energy-efficiency that can explain and/or demonstrate to prospective buyers corresponding features in homes being offered for sale.

2. Description of the Related Art

Subdivisions of homes are known in the modern American landscape. Typically, subdivisions include a limited number of home designs that are repeatedly built throughout the subdivision. Often, the homes in the subdivision will share certain common features, such as architectural style, materials, construction methods, and the like. However, during the construction of the subdivision it can be difficult to persuade prospective buyers to purchase the homes being built. Often, a prospective buyer's hesitancy is at least partially because the prospective buyer is unable to experience the finished home, because the home is still being constructed.

To simulate to prospective buyers what a finished home in the subdivision could look like, a showcase home is often one of the first homes constructed in the subdivision. The showcase home usually includes a completed structure (foundation, supports, windows, roof, and the like), a completed exterior (e.g., paint, landscaping, fixtures, play equipment, and the like), and a completed interior (e.g., drywall on the walls and ceilings, trim, paint, tile and/or carpeting, fixtures, and the like). Furthermore, the showcase home is generally furnished (e.g., furniture, appliances, cookware, lighting, television and stereo, and the like) and decorated (e.g., paintings on the walls, a vase of flowers, a table set for dinner, clothes hanging in the closets, a doormat at the front entrance, and the like). Indeed, often the showcase home is complete with optional finishes and/or upgrades, such as crown molding and upgraded cabinet hardware. All in all, the showcase home is set up to simulate to prospective buyers what their completed home in the subdivision could look like.

### SUMMARY

In many cases, a showcase home does not adequately demonstrate to prospective home buyers the features of homes being offered for sale. This can be at least partly because in modern home construction many features of the home are obscured once construction on the home has been completed. For example, advances in the construction of walls (e.g., studs that do not extend the thickness of the wall, the use and type of insulation, etc.) are not normally visible after the wall has been completed because other materials, such as drywall and paint, obscure such construction from view. Accordingly, a completed showcase home typically does not adequately demonstrate to prospective buyers the features of homes being offered for sale. Used herein, the term “homes being offered for sale” can include homes that are fully built, homes that are partly built, and homes that are planned but for which construction has not yet started.

It is, therefore, a realization that features of homes being offered for sale can be demonstrated by leaving features of a model home partially exposed. Used herein, the term “partially exposed,” and derivatives thereof, means features that are exposed, incomplete, and/or unfinished and that would not be so following standard construction practices. For example, in standard construction practices, in a home having drywall walls, the walls would typically not be left with sections of drywall missing, but such missing sections could be left as a partially exposed feature. Partially exposed features can expose or explain features that are representative of features of the homes being offered for sale. Accordingly, prospective buyers can experience the partially exposed features in the model home and thereby experience corresponding features of the homes being offered for sale—even if the homes being offered for sale is not yet built.

It is also a realization that exposing representative features in a model home can direct and/or educate prospective buyers concerning the features of the homes being offered for sale. For example, the partially exposed features can demonstrate energy-efficient features of the model home that would be representative of energy-efficient features of the homes being offered for sale. Such demonstrations can facilitate prospective buyers in understanding the advantages and benefits of the homes being offered for sale. Used herein, the term “energy-efficient,” and derivatives thereof, refers to features that facilitate the performance of a function for a reduced amount of energy. For example, insulation can inhibit heat transfer between the environment and the interior of the home, so can allow the home to use less heating and cooling energy to achieve and maintain a comfortable temperature. Energy-efficient features are typically also energy-saving. In some cases, energy-efficient features can include the use of alternative-energy sources, such as solar power, wind power, and the like.

Another realization is that prospective buyers' understanding of the representative features can be further enhanced with signage indicating information related to the representative features. For example, prospective buyers may not be familiar with the construction of an exterior wall or how certain aspects of the wall improve the insulating properties of the wall. However, a sign provided near the representative feature can explain such details to the prospective buyers and describe how the representative features would correspond to features of the homes being offered for sale.

It is a further realization that exposing representative features in a model home can facilitate marketing of the homes being for sale. For instance, the partially exposed features can be used to tout the features of the homes being offered sale. Indeed, in homes having energy-efficient elements, which are often passive and/or obscured, partially exposed features can be selling points and/or promotion tools that allow prospective buyers to experience first-hand the benefits of the homes for being offered sale.

Further, it is a realization that a model home that includes partially exposed features can be converted to a home offered for sale by completing the partially exposed features. Prospective buyers may not wish to purchase a home having partially exposed features. For example, prospective buyers may not wish to purchase a model home that includes, for example, a partially exposed feature that is a wall having a missing and/or cut-out portion of drywall thereby exposing the interior construction of the wall. However, the model home can be converted to a finished home by, for example, installing and finishing the missing and/or cut-out portion of the drywall, such that the partially exposed feature appears to have never existed. Thus, the partially exposed features of the model home can be converted to finished features to facilitate the appeal of the model home as a home being offered for sale.

Accordingly, it would be advantageous to provide a model home having partially exposed features that expose and/or explain features that are representative of features in homes being offered for sale and having signage to indicate information related to the partially exposed features. It would be further advantageous to educate prospective home buyers concerning the features of the home for sale with the unfinished features of the model home, to market the homes for sale by employing the same, and to convert the model home to a home for sale by finishing the partially exposed features.

In some arrangements, a method of marketing homes comprises: providing a model home located in a development with a plurality of homes being offered for sale, the homes being offered for sale having energy-efficient features in common with the model home, the energy-efficient features being demonstrated by exhibits located in the model home, at least some of the exhibits including a plurality of incomplete construction features of the structure of the model home, the incomplete construction features being completed in the homes being offered for sale; inviting prospective home buyers to visit the model home; directing the prospective home buyers through the model home; explaining to the prospective home buyers the energy-efficient features of the homes being offered for sale using the incomplete construction features in the model home; and providing the prospective buyer an opportunity to reserve one of the homes being offered for sale.

In some embodiments, the method further includes having the prospective home buyers pay a deposit and sign a document. In some instances, the method further includes converting the model home to a home being offered for sale after a desired number of the homes being offered for sale have been sold, wherein converting includes completing the incomplete construction features in the model home.

In some cases of the method, at least one of the energy-efficient features includes an attic space and an insulated roof, wherein each of the homes being offered for sale include a room positioned below the attic space having a ceiling substantially obscuring the insulated roof, wherein at least one of the plurality of incomplete construction features include the room below the attic space having a portion of the ceiling missing thereby exposing the insulated roof to the prospective home buyers. In some aspects, the portion of the ceiling missing includes substantially the entire ceiling.

In some embodiments of the method, at least one of the energy-efficient features includes an exterior wall having an insulated interior space having a width that is greater than a width of a support stud, wherein the exterior wall in the homes being offered for sale is configured to substantially conceal the insulated interior space, and wherein at least one of the plurality of incomplete construction features include a portion of the exterior wall being configured to expose the insulated interior space. In some arrangements, the width of the insulated interior space is at least 7 inches. In some arrangements, the width of the insulated interior space is at least 9 inches.

In some embodiments, at least one of the plurality of incomplete construction features includes a wall having an exposed portion configured to expose a construction of the wall, the construction of the wall including a support member and wall insulation. In some cases, at least one of the plurality of incomplete construction features includes a comparative light display configured to demonstrate heat produced by a first and a second type of light bulb. In some embodiments, at least one of the plurality of incomplete construction features includes a comparative window display configured to demonstrate insulating efficiency of a first and a second type of window. In some arrangements, at least one of the plurality of incomplete construction features includes a solar panel disposed on the roof and a solar panel display, the solar panel display located in the model home and configured to demonstrate the operation of the solar panel. In some cases, at least one of the plurality of incomplete construction features includes a first sign type configured to denote details of construction features of the home and a second type of sign configured to denote energy-efficient features of the home. In some aspects, at least one of the plurality of incomplete construction features includes a learning area including a plurality of seats and an electronic screen configured to display information pertaining to the model home.

In some arrangements, a partially exposed home encloses an inside space and includes: a foundation supporting the home, the foundation comprising tension members and a support material, the tension members extending across a footprint of the home, the support material substantially encasing the tension members except at an exposed display area, the exposed display area disposed in the inside space; a roof covering the home and having an exterior side and an interior side, the interior side having roof insulation, the roof insulation being exposed to the inside space and illuminated with a light source; a wall having an exposed portion configured to expose a construction of the wall, the construction of the interior wall including a support member and wall insulation; a comparative light display configured to demonstrate heat produced by a first and a second type of light bulb; a comparative window display configured to demonstrate insulating efficiency of a first and a second type of window; a solar panel disposed on the roof and a solar display located in the inside space and configured to demonstrate the operation of the solar panel; a first sign type configured to denote details of construction features of the home and a second type of sign configured to denote energy-efficient features of the home; and a theater area including a plurality of seats and an electronic screen configured to display information pertaining to the home.

In some cases, a method of decorating a model house—the house having a foundation including concrete and tensioned rebar, a plurality of exterior walls defining a living space, a plurality of interior walls, and a roof—includes: encasing the tensioned rebar in the concrete except for an exposed portion, the exposed portion disposed in the living space; covering the foundation with a flooring material except in one or more unfinished rooms; covering the interior walls with a walling material except in one or more unfinished rooms; obscuring the roof with a ceiling material except in the one or more unfinished rooms; locating furniture in the one or more unfinished rooms in order to indicate the intended use of the one or more unfinished rooms in a finished state; and locating displays in the living space, the displays configured to indicate energy-efficient features of the house.

In some arrangements, a method for converting a partially exposed home to a livable home (the partially exposed home comprising a wall display with an area of exposed wall construction, a room having a portion missing an interior ceiling in order to expose a roof insulation display illuminated by a light source, a foundation display having a recessed area of exposed tension members, and signage located adjacent to and describing each of the wall display, roof insulation display, and foundation display) includes: adding concrete to substantially fill the recessed area; covering the area of exposed wall construction with a walling material; removing the light source; installing an interior ceiling in the portion missing, thereby blocking visual access to the roof insulation display; and removing the signage.

### BRIEF DESCRIPTION OF THE DRAWINGS

FIG. 1 illustrates a plan view of an embodiment of a subdivision.

FIG. 2 illustrates a plan view of an embodiment of a model home complex that can be disposed in the subdivision of FIG. 1.

FIG. 3 illustrates a plan view of an embodiment of a partially exposed model home that can be part of the model home complex of FIG. 2.

FIGS. 4A-J illustrate partial elevation views of walls with partially exposed features that can be included in the partially exposed model home of FIG. 3.

FIG. 5 illustrates a partial elevation view of the exterior of the partially exposed model home of FIG. 3.

FIG. 6 schematically illustrates a method of marketing a home with an embodiment of a partially exposed model home.

### DETAILED DESCRIPTION

A variety of model homes are described below to illustrate various examples that may be employed to achieve the desired improvements. These examples are only illustrative and not intended in any way to restrict the general inventions presented and the various aspects and features of these inventions. The phraseology and terminology used herein is for the purpose of description and should not be regarded as limiting. No features, structure, or step disclosed herein is essential or indispensible.

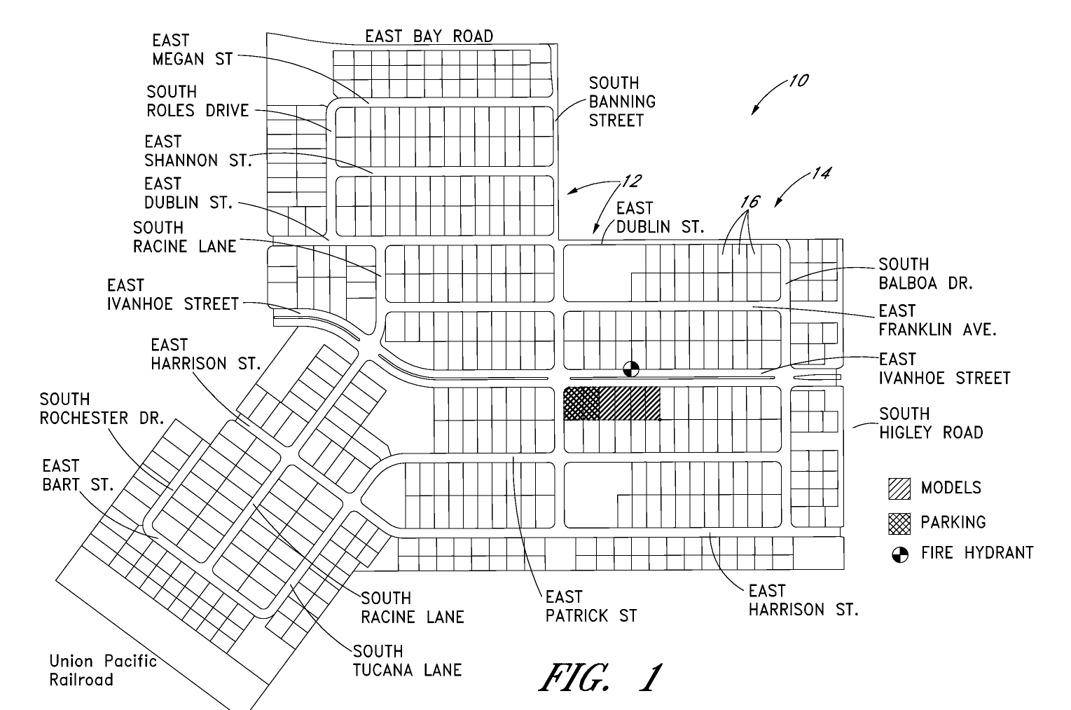

With regard to FIG. 1, a non-limiting embodiment of a typical subdivision 10 is illustrated. In some cases, the subdivision 10 is divided by a plurality of paths 12 (e.g., roads or streets) into blocks 14. As shown, the blocks 14 can be further divided into a plurality of tracts 16. Each of the tracts 16, in turn, can be used for a variety of purposes, such as residential, commercial, retail, parkland, schools, etc. However, it is common for many of the tracts 16 to share a common purpose. Often, the purpose is residential, in which case many of the tracts 16 in the subdivision 10 can include some type of housing structure, such as a single-family home, multi-family home, townhome, condo, and the like. For example, in some cases, each of the tracts 16 includes a single-family house or is planned to include a single-family house.

The subdivision 10 typically includes a limited number of housing designs that are repeated throughout the subdivision 10. For example, the subdivision 10 may include eight basic home designs, with each of the eight home designs having a particular floorplan and room configuration. Often, each of the home designs will share similar aesthetics, architectural styles, building styles, materials, and/or sizes, with the other home designs. For instance, each of the home designs of the subdivision may be ranch-style homes. In other arrangements, the subdivision 10 includes a mixture of housing designs, such as a mix of single and double-story homes. In some cases, each of the home designs in the subdivision 10 share common energy-efficient features, such as solar panels on the roof, extra-thick and insulated walls, insulated attic spaces, and the like.

Generally, a developer purchases the land on which the subdivision 10 is to be built. In some cases, the developer divides the land into the tracts 16 and coordinates with others, e.g., architects, general contractors, tradespersons, etc. to construct homes on each of the tracts 16. During the construction process of the subdivision 10, the developer is typically simultaneously seeking to sell or encourage interest in the purchase of the tracts 16 and/or homes thereon (or that will be built thereon).

It can, however, be challenging to convince prospective buyers to purchase a home sight unseen. Accordingly, in some cases, a developer will construct a model home complex 20 on one or more of the tracts 16. The model home complex 20 typically includes homes that are representative of the homes to be built on one or more tracts 16 of the subdivision 10. For example, the model home complex 20 can include one or more single-family homes in accordance with the building design, e.g., architectural design, floor plan, etc., that is being offered for sale on one or more of the tracts 16. To facilitate advertising and/or increase visibility, the model home complex 20 is typically constructed on a thoroughfare of the subdivision 10 and/or near a well-traveled nearby street or road.

Generally, prospective buyers are encouraged to visit and/or invited to access to the model home complex 20—often even before each of the homes in the subdivision 10 has been completed. The model home complex 20 typically offers tours and information pertaining to the homes being offered for sale in the subdivision 10. Accordingly, prospective buyers can experience an example of what homes in the subdivision 10 would look like. In many cases, the developer and/or a third party, e.g., a realtor, will stage the homes of the model home complex 20 so that the interior of the model home complex homes appear to be lived in by real families. For example, in some cases, the model homes include furniture, bedding, cookware, decor, pictures, and the like, such that when the prospective buyer enters one of the model homes, it appears that they are not walking into an empty house, but rather, into a friend's house, or even their own imagination of what their home could be.

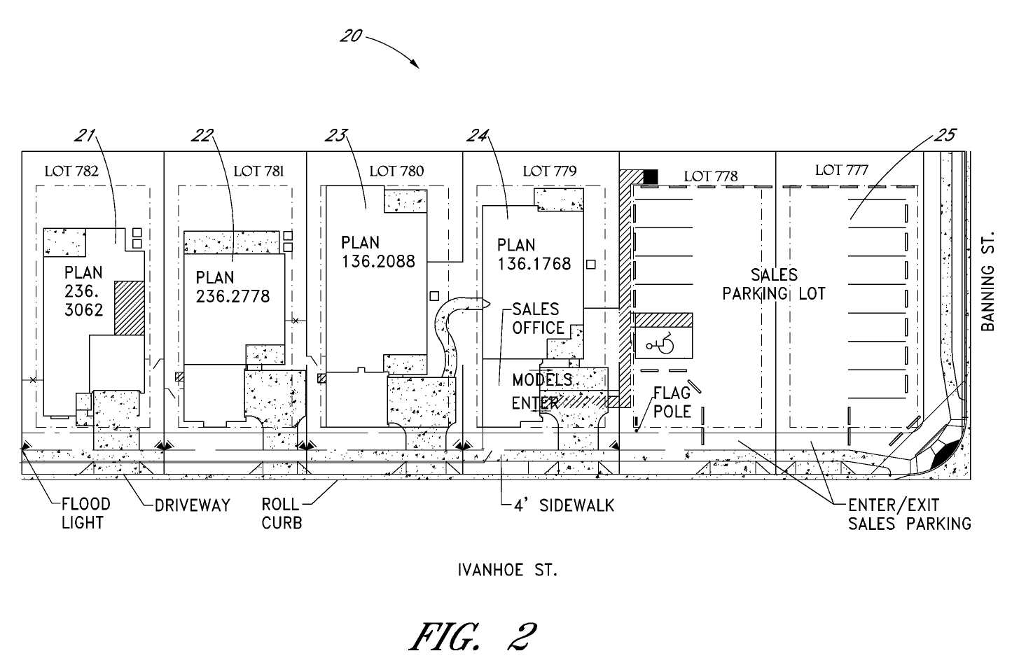

With regard to FIG. 2, a non-limiting embodiment of the model home complex 20 is depicted. The model home complex can include a plurality of model complex homes 21-24. This can beneficially allow prospective buyers to experience the aesthetics and general feel of a portion of the subdivision 10 overall, rather than simply one home within the subdivision 10. In some cases, each of the model homes 21-24 are constructed according to the same building design, e.g., floorplan, arrangement of rooms, number of floors, etc. In other cases, a first model home 21 may be constructed according to a first building design, a second model home 22 may be constructed according to a second building design, a third home 23 may be constructed according to a third building design, and a fourth home 24 may be constructed according to a fourth building design. A parking lot 25 can be temporarily installed in an area of the subdivision 10, such as on one or more tracts 16. Thus, parking can be made readily accessible for prospective buyers visiting the model home complex 20. In some instances, when a desired number of the tracts 16 in the subdivision 10 have been purchased, or at such time as the model home complex 20 is deemed no longer needed, the parking lot 25 can be removed. Further, in some aspects, homes can be built on the territory previously occupied by the parking lot 25.

To aid in marketing and/or to assist in directing prospective purchasers, temporary implements may be installed at the model home complex 20. For example, a fence may be installed around a portion of the perimeter of the model home complex 20, which can aid in inhibiting prospective buyers from venturing outside of the model home complex and into the construction zone of the subdivision 10. In some arrangements, additional lighting, such as floodlights, are installed to aid in illumination of the model home complex 20 and/or improve the aesthetics of the model houses 21-24. Further, one or more signs can be erected with indicia indicating, for example, the name of the subdivision 10, contact information, and/or pricing information.

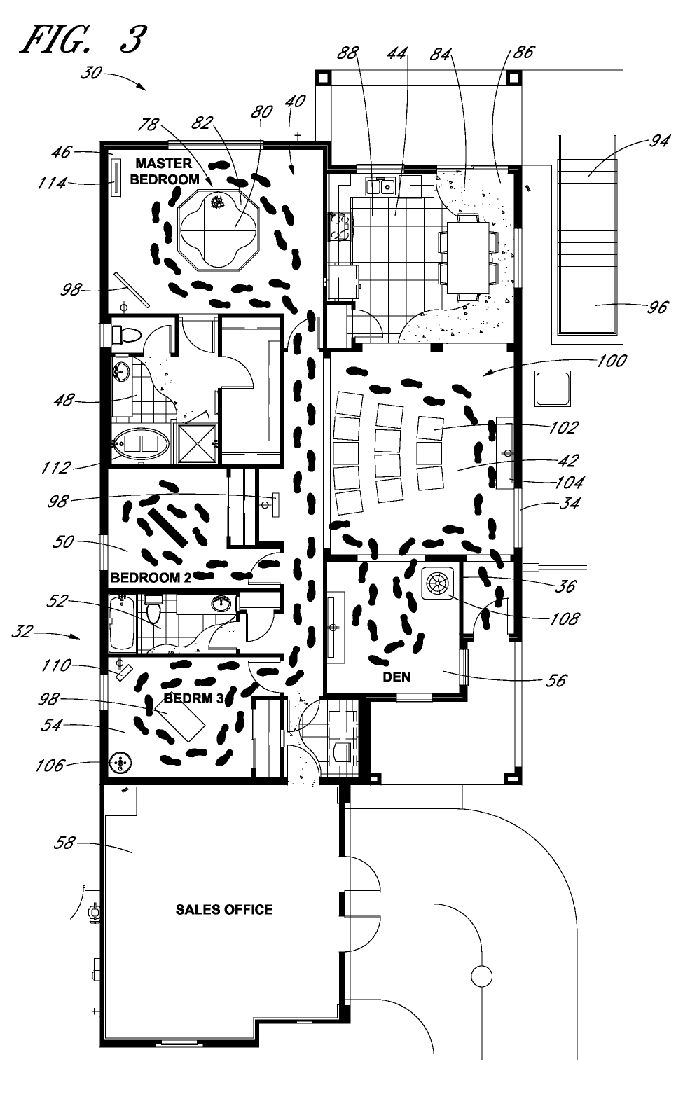

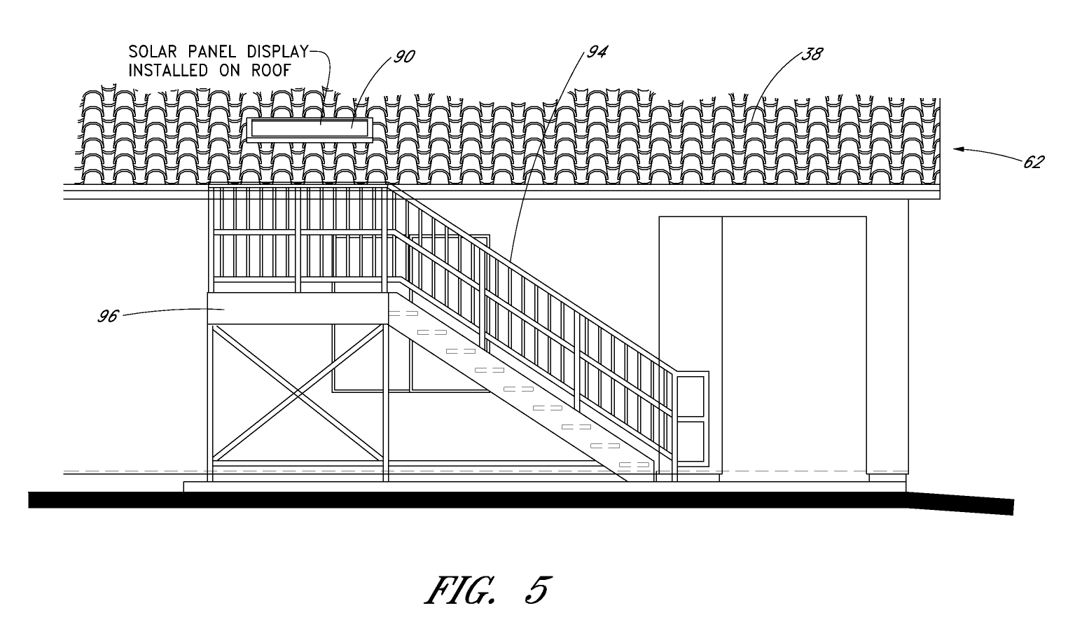

Turning now to FIG. 3, a non-limiting embodiment of a model home 30 in the model home complex 20 is illustrated. The model home 30 can include a foundation 32, exterior walls 34, interior walls 36 and a roof 38 (not shown). The model home 30 can generally contain a living space 40, which is the general area enclosed by the exterior walls 34 of the model home 30. For example, in the illustrated model house 30, the living space 40 includes a living room 42, kitchen 44, master bedroom 46, master bathroom 48, second bedroom 50, guest bathroom 52, third bedroom 54, den 56, and garage 58. In some cases, the model home may include an attic space 62 (FIG. 5). The attic space 62 is typically disposed between an interior side 64 (not shown) of the roof 38 and the livable space 40. The livable space normally includes a ceiling 66 (not shown), which normally includes sheets of drywall, mineral fiber, fiberglass, or other such material, that are fastened to, or suspended from, horizontal support members (e.g., joists), thereby visually obscuring and separating the attic space 62 from the livable space 40.

In some embodiments, the garage 58 is used as a sales office during the time period that the model home complex 20 is open. Often, the sales office includes one or more salespeople (e.g., realtors) knowledgeable about the model home 30 and features therein. Prospective buyers can enter the sales office to meet with the salespeople and/or tour the model home 30. In some cases, a tour map is provided to the prospective buyers. In some embodiments, signage assists prospective buyers on their tour. For example, the model home 30 can include signs, arrows, pointers, footprints, or the like to guide prospective buyers through the model home 30 on a self-guided tour. In addition, the signage can provide information and details pertaining to the energy-efficient features of the model home 30 and provide indications of items of interest in the model home 30. For example, a sign can indicate to prospective buyers to look upward to notice energy-efficient features located on the roof 38, such as insulation. The signage may also identify to the prospective buyers what they are looking at and why it is beneficial. Further, the signage can provide other information, such as indicating that the insulated roof 38 can facilitate a substantially uniform temperature between the attic space 62 and the living space 40.

Generally, the model home 30 includes one or more partially exposed features 70. The partially exposed features 70 can provide information to prospective buyers regarding benefits and/or features of the model home 30. Further, the partially exposed features 70 can emphasize features of the model home 30 that are representative of the homes being offered for sale. The partially exposed features 70 can include, for example, demonstrations, exhibits, displays, comparisons, and the like. Typically, the partially exposed features 70 are disposed within the livable space 40. Often, the partially exposed features 70 pertain to energy efficient features of the model home 30. Examples of various partially exposed features 70, and methods of use of the same, are discussed in further detail below.

Some embodiments of the model home 30 include a partially exposed ceiling 72 (not shown). As discussed above, a ceiling 66 normally separates and obscures the attic space 62 from the living space 40. However, it can be advantageous to provide prospective buyers visual access to the attic space 62, as well as the interior side 64 of the roof 38. For example, in some cases, the model home 30 includes insulation on the interior side 64 of the roof 38, which can provide enhanced energy efficiency and can enhance the appeal of the home to a prospective buyer. Thus, some embodiments of the model home 30 have the partially exposed ceiling 72 to permit prospective buyers visual and/or physical access to the attic space 62, which can highlight to prospective buyers certain beneficial features of the model home 30 that are representative of the homes being offered for sale. In some cases, the partially exposed ceiling 72 includes a portion of the ceiling 66 that is missing. In other arrangements, the partially exposed ceiling 72 includes substantially all of the ceiling 66 being missing. Furthermore, in some cases, temporary lighting is installed to illuminate the attic space 62 and/or the interior side 64 of the roof 38 and to aid prospective buyers in viewing such spaces and the energy-efficient features therein. For example, the temporary lighting can be directed to highlight insulation on the interior side 64 of the roof 38.

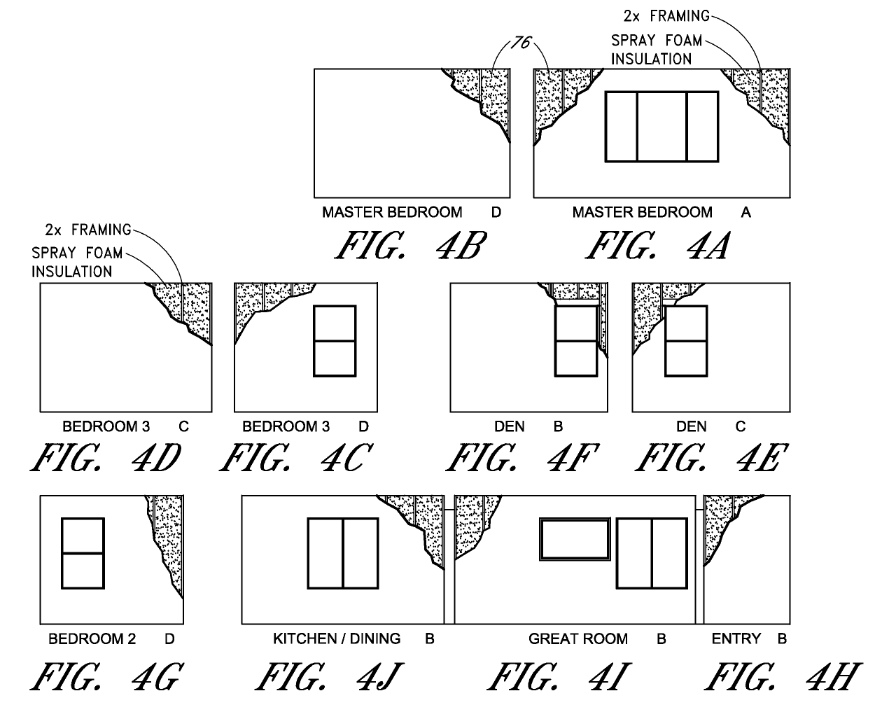

With reference to FIGS. 3 and 4A-J, some embodiments of the model home 30 include a partially exposed wall 74. Typically, the partially exposed wall 74 is configured to expose the interior construction of the wall to prospective buyers, thus touting to prospective buyers certain beneficial features of the model home 30 that are representative of the homes being offered for sale. In some cases, the partially exposed wall 74 is an interior wall 36. For instance, the partially exposed wall 74 can be an interior wall 36 that includes sheets of drywall spaced-apart by or more studs, an insulation material (e.g., spray-foam insulation, fiberglass batting, cellulose, etc.) substantially filling the space therebetween, and a cut-out area 76 in one or more of the drywall sheets to provide a view of the studs and insulation material. In some arrangements, the partially exposed wall 74 is an exterior wall 34. For example, the partially exposed wall 74 can be an exterior wall 34 that includes a layer of exterior sheathing and a layer of drywall spaced-apart by one or more studs, an insulation material (e.g., spray-foam insulation) substantially filling the space therebetween, and a cut-out area 76 in the drywall layer that allows prospective buyers to view the internal construction of the partially exposed wall 74. In some cases, the cut-out area 76 is an area in which at least some of the drywall has not been installed. In some embodiments, the cut-out area 76 is an area in which the drywall was installed but of which a portion has been removed, such as a notch, hole, or the like. In some instances, the partially exposed wall 74 is a stand-alone model of a portion of a wall of the model home 30.

Typically, the partially exposed wall 74 is configured to demonstrate the insulating properties of the wall 34. In some arrangements, the partially exposed wall 74 is an exterior wall 34 and allows prospective buyers to see that the width of the wall is wider than any one of the studs. In other words, the partially exposed wall 74 can be configured to show that no single stud spans the full width between the exterior sheathing and the drywall. The partially exposed wall 74 can also explain to prospective buyers that such a wall configuration can decrease the transfer of heat and provide enhanced insulating properties, and thus promote the overall energy efficiency of the model home 30. Furthermore, the partially exposed wall 74 can be configured to demonstrate to prospective buyers access the use of modern insulation materials (e.g., spray-foam insulation), which can further enhance energy-efficiency.

Some embodiments of the model home 30 include a partially exposed foundation display 78 configured to demonstrate the construction of the foundation 32. Typically, the foundation 32 of the model home 30 includes a compression material 80 (e.g., concrete) substantially enclosing a network of tensioned members 82 (e.g., rebar under a tension force). Employing tensioned members 82 can be advantageous over other types of foundation designs, but such a configuration can go unnoticed by prospective buyers since the tensioned members 82 are normally obscured by the compression material 80. The partially exposed foundation display 78 on the other hand, can tout this feature to prospective buyers. Typically, the partially exposed foundation display 78 includes a recessed area that is substantially free of the compression material 80, thereby exposing the tension members 82 to prospective buyers. Further, the partially exposed foundation display 78 is normally located in the livable space 40, thus providing convenient access when prospective buyers tour the model home 30. For safety, often a fence is erected around the partially exposed foundation display 78 to inhibit prospective buyers from venturing therein.

Some embodiments of the model home 30 include a floor 84 having a base (e.g., concrete) 86 covered with a flooring material 88 (e.g., tile, carpet, wood, etc.). For example, in the kitchen 44 the base 86 may be covered with a ceramic tile flooring material 88. To assist the prospective buyer in understanding the construction of the floor 88, some instances of the model home 30 include a section in which the flooring material 88 is missing, thereby allowing prospective buyers to experience the different components of the floor 84.

Some embodiments of the model home 30 include a solar panel display 90. The model home 30 can include a solar panel 92 (FIG. 5) disposed on the roof 38, which can gather and convert solar energy to electrical energy and/or thermal energy to, for example, operate appliances or heat water. Typically, the solar panel display 90 is a non-functioning version of the solar panel 92 and includes information and/or instructions pertaining to the benefits of the solar panel 92. In some arrangements, the solar panel display 90 is located in the livable space 40, so as to provide convenient access when prospective buyers tour the model home 30. In some embodiments, the model home 30 includes a staircase 94 located outside the model home 30 and leads to a viewing platform 96 from which prospective buyers can view the solar panel 92 on the roof 38. Often, when model home 30 is converted to a home being offered for sale (as discussed below) the staircase is removed.

In some embodiments, the model home 30 includes a comparison demonstration 98, which can provide the prospective buyers sensory comparisons of different energy-efficient features of the model home 30 compared to the features of a conventional home. For example, in some cases, the comparison demonstration 98 includes a comparison display regarding lighting, which can include an incandescent bulb, a compact fluorescent (CFL) bulb, and a light-emitting diode (LED) bulb. In some cases, each of the bulbs are enclosed in a separate box having at least one transparent or translucent side (e.g., a side constructed of glass, acrylic, or the like). Typically, each of the bulbs are able to be illuminated, such that the prospective homebuyer, when touching each of the boxes, can compare the heat generation—and thus the energy-efficiency—of each of the bulbs. Further, the comparison demonstration 98 can provide information about which type of bulb is installed in the model home 30 and/or would be available to be installed in the homes being offered for sale in subdivision 10.

In some embodiments, the comparison demonstration 98 can include a window display in which different types of windows (e.g. single-pane, double-pane, and low-E) are able to be compared by a prospective buyer. In some cases, each of the windows are positioned near or on a surface and have a heat source on a side of the windows opposite from the prospective buyer. Thus prospective buyers can touch the windows to experience the amount of heat transmitted through each of the windows, and thus better understand the insulating properties of the different varieties of windows. Further, the comparison demonstration 98 can provide prospective buyers information concerning which of the type of window is installed in the model home 30 and/or available for installation in the homes being offered for sale in the subdivision 10.

In some embodiments, the comparison demonstration 98 includes an insulation display, whereby different types of insulation (e.g., spray-foam insulation, fiberglass batting, and cellulose), can be visually examined side-by-side, and whereby the insulating properties of each of the types of insulation can be compared. Further, the comparison demonstration 98 can provide prospective buyers information pertaining to which type of insulation is installed in the model home 30 and/or are available to be installed in the homes being offered for sale in the subdivision 10.

Moreover, some instances of the model home 30 include a learning center 100. The learning center 100 can include, for example, seating 102, an electronic screen 104, and printed materials available for prospective buyers to take. The electronic screen 104 is normally configured to provide prospective buyers an overview of the beneficial features of the model home 30. In some cases, the learning center 100 is located such that prospective buyers enter and/or encounter the learning center soon after entering the model home 30.

Many other types of partially exposed features 70 can be located in the model home 30 as well. In some aspects, the model home includes non-functioning versions of a water heater 106, an air conditioning condensing unit 108, a weather display 110, and/or a water usage display 112. In some embodiments, the model home 30 includes an insulated garage door display 114, which can explain to prospective buyers that the garage doors in the homes being offered for sale can inhibit heat transfer and provide beneficial acoustic damping properties.

Advantageously, the model home 30 can be converted into a home being offered for sale. Generally, converting the model home 30 includes making it appear as if the partially exposed features have never existed. Often, such a conversion will make the model home 30 more appealing to be purchased by prospective buyers. For example, the model home 30 can be converted to home being offered for sale by filling-in the partially exposed foundation display 78 with compression material 82, such that the tensioned members 84 are substantially encased in compression material 84; completing the flooring material 84 so as to largely cover the base 86; installing drywall in the cut-out area 76 of the partially exposed wall 74 so that the interior construction is obscured and the cut-out area 76 appears to never have existed. Additionally, the sales office can be removed from the garage 58 and a garage door may be installed. Further, the variety of exhibits, such as the comparison demonstrations 98, can be removed from the model house 30. Accordingly, the model house 30 can be converted from a representative model having exposed, incomplete, and/or temporary features to a home having completed permanent features and that is ready to be offered for sale.

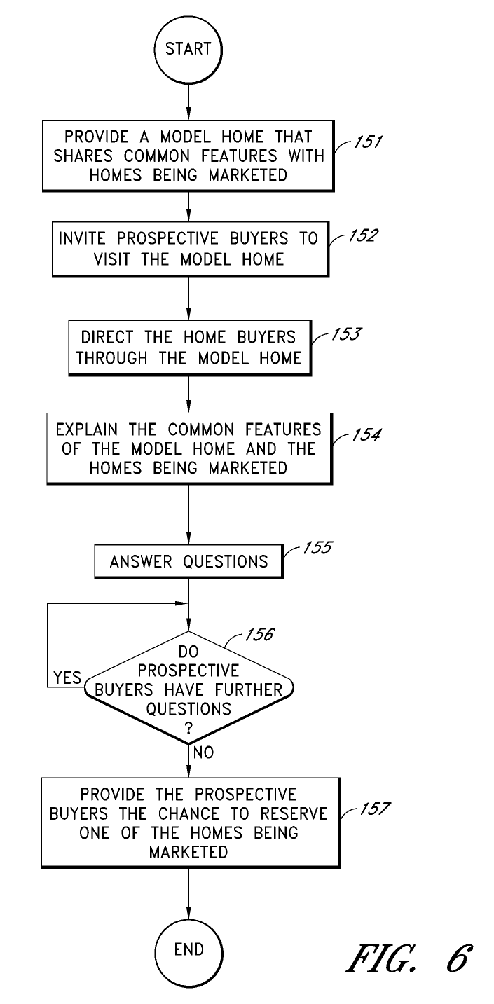

With regard to the non-limiting embodiment of FIG. 6, the invention can include a method for marketing (e.g., offering for sale) one or more homes. A first block 151 of the method can include providing and/or obtaining a model home with certain features in common with one or more of the homes being marketed. In some embodiments, the common features are energy-efficient features. In some cases, the model home is part of a model home complex, which can include more than one model home. A second bock 152 can include inviting prospective buyers into the model home. Inviting prospective buyers can include signs, personal invitations, word-of mouth, advertisements, placards, and most any other way to indicate to prospective buyers that they are welcome at, and encouraged to visit, the model home. In some arrangements, a parking lot is provided to provide readily accessible parking for the prospective buyers. Next, in block 153 the prospective buyers can be directed through the model home. For example, a person (e.g., a tour-guide, realtor, etc.) can direct the prospective buyers. In some cases, the prospective buyers are provided with a tour map configured to lead the prospective buyers through the house on a self-guided tour. A fourth block 154 can include explaining the common features of the model home and the homes being marketed. Often, the explanation can be accomplished with one or more partially exposed features, as discussed above. In a fifth block 155, the prospective buyers' questions are answered, such as by the tour-guide or a salesperson. Next, an inquiry is made in decision block 156 as to whether the prospective buyers have further questions. If the answer is affirmative, then the method loops back to block 155 for further answers. If the answer is negative, then the method continues to block 157, in which the prospective buyers can be given an opportunity to reserve one of the homes being marketed. For example, the prospective buyers may be given a chance to put down a deposit and/or sign a document. The method then ends.

Although the model home and associated methods of use has been disclosed in the context of certain preferred embodiments and examples, it will be understood by those skilled in the art that the model home and associated methods of use extends beyond the specifically disclosed embodiments to other alternative embodiments and/or uses of the invention and obvious modifications and equivalents thereof. It should be understood that various features and aspects of the disclosed embodiment can be combined with or substituted for one another in order to form varying modes of the model home and associated methods of use. Thus, it is intended that the scope of the model home and methods of use thereof herein-disclosed should not be limited by the particular disclosed embodiments described above, but should be determined only by a fair reading of the claims that follow.

What is claimed is:

1. A method of marketing homes, comprising:
providing a model home located in a development with a plurality of homes being offered for sale, the homes being offered for sale having energy-efficient features in common with the model home, the energy-efficient features being demonstrated by exhibits located in the model home, at least some of the exhibits including a plurality of incomplete construction features of the structure of the model home, the incomplete construction features being completed in the homes being offered for sale;
inviting prospective home buyers to visit the model home;
directing the prospective home buyers through the model home;
explaining to the prospective home buyers the energy-efficient features of the homes being offered for sale using the incomplete construction features in the model home; and
providing the prospective buyer an opportunity to reserve one of the homes being offered for sale.

2. The method of claim 1, further comprising the step of having the prospective home buyers pay a deposit and sign a document.

3. The method of claim 1, further comprising the step of converting the model home to a home being offered for sale after a desired number of the homes being offered for sale have been sold, wherein converting includes completing the incomplete construction features in the model home.

4. The method of claim 1, wherein at least one of the energy-efficient features comprises an attic space and an insulated roof, wherein each of the homes being offered for sale include a room positioned below the attic space having a ceiling substantially obscuring the insulated roof, wherein at least one of the plurality of incomplete construction features comprises the room below the attic space having a portion of the ceiling missing thereby exposing the insulated roof to the prospective home buyers.

5. The method of claim 4, wherein the portion of the ceiling missing comprises substantially the entire ceiling.

6. The method of claim 1, wherein at least one of the energy-efficient features comprises an exterior wall having an insulated interior space having a width that is greater than a width of a support stud, wherein the exterior wall in the homes being offered for sale is configured to substantially conceal the insulated interior space, and wherein at least one of the plurality of incomplete construction features comprises a portion of the exterior wall being configured to expose the insulated interior space.

7. The method of claim 6, wherein the width of the insulated interior space is at least 7 inches.

8. The method of claim 1, wherein at least one of the plurality of incomplete construction features comprises a wall having an exposed portion configured to expose a construction of the wall, the construction of the wall including a support member and wall insulation.

9. The method of claim 1, wherein at least one of the plurality of incomplete construction features comprises a comparative light display configured to demonstrate heat produced by a first and a second type of light bulb.

10. The method of claim 1, wherein at least one of the plurality of incomplete construction features comprises a comparative window display configured to demonstrate insulating efficiency of a first and a second type of window.

11. The method of claim 1, wherein at least one of the plurality of incomplete construction features comprises a solar panel disposed on the roof and a solar panel display, the solar panel display located in the model home and configured to demonstrate the operation of the solar panel.

12. The method of claim 1, wherein at least one of the plurality of incomplete construction features comprises a first sign type configured to denote details of construction features of the home and a second type of sign configured to denote energy-efficient features of the home.

13. The method of claim 1, wherein at least one of the plurality of incomplete construction features comprises a learning area including a plurality of seats and an electronic screen configured to display information pertaining to the model home.

14. A partially exposed home enclosing an inside space, comprising:
a foundation supporting the home, the foundation comprising tension members and a support material, the tension members extending across a footprint of the home, the support material substantially encasing the tension members except at an exposed display area, the exposed display area disposed in the inside space;
a roof covering the home and having an exterior side and an interior side, the interior side having roof insulation, the roof insulation being exposed to the inside space and illuminated with a light source;
a wall having an exposed portion configured to expose a construction of the wall, the construction of the interior wall including a support member and wall insulation;
a comparative light display configured to demonstrate heat produced by a first and a second type of light bulb;
a comparative window display configured to demonstrate insulating efficiency of a first and a second type of window;
a solar panel disposed on the roof and a solar display located in the inside space and configured to demonstrate the operation of the solar panel;
a first sign type configured to denote details of construction features of the home and a second type of sign configured to denote energy-efficient features of the home; and
a theater area including a plurality of seats and an electronic screen configured to display information pertaining to the home.

15. A method of decorating a model house, the house having a foundation including concrete and tensioned rebar, a plurality of exterior walls defining a living space, a plurality of interior walls, and a roof, the method comprising:
encasing the tensioned rebar in the concrete except for an exposed portion, the exposed portion disposed in the living space;
covering the foundation with a flooring material except in one or more unfinished rooms;
covering the interior walls with a walling material except in the one or more unfinished rooms;
obscuring the roof with a ceiling material except in the one or more unfinished rooms;
locating furniture in the one or more unfinished rooms in order to indicate the intended use of the one or more unfinished rooms in a finished state; and
locating displays in the living space, the displays configured to indicate energy saving features of the house.
